(19) United States
(12) Patent Application Publication
(10) Pub. No.: US 2023/0389549 A1
(43) Pub. Date: Dec. 7, 2023

(54) Fungicidal Combinations

(71) Applicants: UPL Corporation Limited, Port Louis (MU); UPL Europe LTD, Warrington (GB)

(72) Inventor: Ayrton Neto, Port Louis (MU)

(21) Appl. No.: 18/250,410

(22) PCT Filed: Oct. 25, 2021
(86) PCT No.: PCT/GB2021/052757

§ 371 Date: Apr. 25, 2023

(30) Foreign Application Priority Data
Oct. 26, 2020 (GB) 2016943.9

(51) Int. Cl. A01N 43/653; A01P 3/00; A01N 47/14; A01N 43/40

(52) U.S. Cl. CPC A01N 43/653; A01P 3/00; A01N 47/14; A01N 43/40

(57) ABSTRACT

Described herein are fungicidal combinations and compositions including at least one multisite fungicide and at least three systemic fungicides. Methods of controlling a fungal disease in a crop or a locus include applying an effective amount of the disclosed fungicidal combinations to the crop or to the locus.

### TECHNICAL FIELD

The present disclosure relates to combinations of fungicides. More specifically, the present disclosure relates to fungicidal combinations comprising multisite fungicides with systemic fungicides for controlling a broad spectrum of fungal diseases.

### BACKGROUND

Fungicides are an integral and important tool wielded by farmers to control diseases, as well as to improve yields and quality of the crops. There are various fungicides that have been developed over the years with many desirable attributes such as specificity, systemicity, curative and eradicant action and high activity at low use rates.

There are various types of fungicides, including multi-site fungicides and systemic fungicides. However, as crop tolerance decreases, lower use rates are imposed, and fungal resistance is increasingly observed, there is a need for alternative treatments having broader disease control, curative and preventive functions, and a lower dosage requirement.

The multi-site contact fungicides of the present invention inhibit fungal growth through multiple sites of action and have contact and preventive activity. Multi-site contact fungicides include copper fungicides, sulfur fungicides, dithiocarbamate fungicides, phthalamide fungicides, chloronitrile fungicides, sulfamide fungicides, guanidine fungicides, triazines fungicides and quinone fungicides.

Succinate dehydrogenase inhibitor (SDHI) fungicides are systemic fungicides. Pyrazolecarboxamides are a group of active compounds within the SDHI family of fungicides that are known to be more potent than most other SDHI fungicides. These molecules specifically bind to the ubiquinone-binding site (Q-site) of the mitochondrial complex II, thereby inhibiting fungal respiration. These fungicides are known to control a broad spectrum of fungal diseases. Benodanil, Flutolanil, Mepronil, Isofetamid, Fluopyram, Fenfuram, Carboxin, Oxycarboxin, Thifluzamide, Benzovindiflupyr, Bixafen, Fluxapyroxad, Furametpyr, Isopyrazam, Penflufen, Penthiopyrad, Sedaxane, Boscalid, Pydiflumetofen, Fluindapyr, Pyraziflumid, Isoflucypram, Inpyrfluxam and Dipymetitrone are examples of SDHI fungicides.

Demethylation inhibitor (DMI) fungicides are systemic fungicides and inhibit fungal growth by inhibiting the ergosterol biosynthesis and thus plasma membranes. Azaconazole, Bitertanol, Bromuconazole, Cyproconazole, Difenoconazole, Diniconazole, Epoxiconazole, Etaconazole, Fenbuconazole, Fluquinconazole, Flusilazole, Flutriafol, Hexaconazole, Imibenconazole, Ipconazole, Metconazole, Myclobutanil, Penconazole, Propiconazole, Simeconazole, Tebuconazole, Tetraconazole, Triadimefon, Triadimenol, Triticonazole, Prothioconazole, Imazalil, Oxpoconazole, Pefurazoate, Prochloraz, Triflumizole, Triforine, Pyrifenox, Pyrisoxazole, Fenarimol, Nuarimol, Mefentrifluconazole and Ipfentrifluconazole are examples of DMI fungicides.

Quinone outside inhibitor (QoI) fungicides are systemic fungicides and act at the Quinone ‘outer’ (Qo) binding site of the cytochrome bc1 complex. Azoxystrobin, Coumoxystrobin, Enoxastrobin, Flufenoxystrobin, Picoxystrobin, Pyraoxystrobin, Mandestrobin, Pyraclostrobin, Pyrametostrobin, Triclopyricarb, Kresoxim-Methyl, Dimoxystrobin, Fenaminostrobin, Metominostrobin, Famoxadone, Fluoxastrobin, Fenamidone, Pyribencarb and Metyltetraprole are examples of QoI fungicides.

There is a need in the art for combinations of these quinone outside inhibitor (QoI), demethylation inhibitor (DMI), succinate dehydrogenase inhibitor (SDHI) fungicides with other fungicides that help improve spectrum and overcome the resistance seen with these fungicides. As crop tolerances are decreasing, lower use rates being imposed and resistance being increasingly observed, there is a need for a combination of actives that allows for broader disease control spectrum that combines curative and preventive actives and has a lower dosage requirement for efficacious control of fungi.

Therefore, embodiments of the present disclosure may ameliorate one or more of the above-mentioned problems:

### One or More Objectives:

An objective of the present disclosure is to provide fungicidal combinations that cause less or no phytotoxicity.

Yet another objective of the present disclosure is to provide a fungicidal combination that results into reduced fungal disease incidence in the crops to which it is applied.

Another objective of the present disclosure is to provide a fungicidal combination that achieves increased yield in the crops to which it is applied.

Some or all these and other objectives of the disclosure are can be achieved by way of the invention described hereinafter.

### SUMMARY

An aspect of the present disclosure can provide a fungicidal combination comprising at least one multisite fungicide and at least three systemic fungicides.

An aspect of the present disclosure provides a method of controlling a fungal disease in a crop or a locus, comprising applying the disclosed fungicidal combinations to the crop or to the locus.

Another aspect of the present disclosure provides synergistic fungicidal compositions comprising at least one multisite fungicide and at least three systemic fungicides.

### DETAILED DESCRIPTION

The term “disease control” as it relates to fungal diseases herein denotes control (treatment) and prevention of a disease. Controlling effects include deviation from natural development of the disease, for example, killing of the fungal agent, retardation of disease development, and decrease in amount of the fungal disease.

The term “plant” encompasses all of the physical parts of a plant, including for example, seeds, seedlings, saplings, roots, tubers, stems, stalks, foliage, and fruits.

The term “locus” as used herein refers to the vicinity, area, or place in which the plants are growing, where plant propagation materials of the plants are sown, and/or where the plant propagation materials of the plants will be placed into the soil.

The term “plant propagation material” is understood to denote generative parts of a plant, such as seeds, vegetative material such as cuttings or tubers, roots, fruits, tubers, bulbs, rhizomes, and other parts of plants, germinated plants, and/or young plants which are to be transplanted after germination or emergence from the soil. These young plants may be protected prior to transplantation by a total or partial immersion treatment/system.

As used herein, “effective amount” is an amount of active ingredient, such as the disclosed combinations, which has an adverse effect on a fungus and/or which prevents a fungal disease in a plant. The adverse effect can include killing of the fungus (fungicidal), preventing growth of the fungus, blocking of biosynthetic pathway(s), or a combination thereof.

As used herein, an “agriculturally acceptable salt” means a salt which is known and accepted for use in agricultural or horticultural use.

“Phytotoxicity” refers to a toxic (negative) effect on the growth of a plant.

“Alkyl” as used herein means a straight or branched chain saturated aliphatic hydrocarbon having the specified number of carbon atoms, specifically 1 to 12 carbon atoms, more specifically 1 to 6 carbon atoms. Alkyl groups include, for example, groups having from 1 to 50 carbon atoms (C₁ to C₅₀ alkyl). “Aryl,” means a cyclic moiety in which all ring members are carbon and at least one ring is aromatic, the moiety having the specified number of carbon atoms, specifically 6 to 24 carbon atoms, more specifically 6 to 12 carbon atoms. More than one ring may be present, and any additional rings may be independently aromatic, saturated or partially unsaturated, and may be fused, pendant, spirocyclic or a combination thereof. “Alkylaryl” means an alkyl group covalently linked to a substituted or unsubstituted aryl group that is linked to a compound.

There is a need for a combination of anti-fungal (e.g., fungicidal) active agents that allows for broader spectrum of disease control, combines curative and preventive activity, and has a lower dosage requirement for efficacious control of fungi. It has surprisingly been found that the combination of at least three systemic fungicides and at least one multisite fungicide results in a surprising and unexpected synergy on fungal growth control and prevention of fungal disease.

The multi-site contact fungicides of the present disclosure inhibit fungal growth through multiple sites of action and have contact and preventive activity. In an embodiment, the multi-site contact fungicides include one or more of copper fungicides, sulfur fungicides, dithiocarbamate fungicides, phthalimide fungicides, chloronitrile fungicides, sulfamide fungicides, guanidine fungicides, triazines fungicides and quinone fungicides.

The copper fungicides of the present disclosure are inorganic compounds containing copper, typically in the copper (II) oxidation state and are preferably selected from copper oxychloride, copper sulfate, copper hydroxide and tribasic copper sulfate (Bordeaux mixture). The sulfur fungicides of the present disclosure are inorganic chemicals containing rings or chains of sulfur atoms and is preferably elemental sulfur. The dithiocarbamate fungicides of the present disclosure contain a dithiocarbamate molecular moiety and include one or more of amobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb and zineb. The phthalamide fungicides of the present disclosure contain a phthalamide molecular moiety and include one or more of folpet, captan and captafol. The chloronitrile fungicide of the present disclosure comprises an aromatic ring substituted with chloro- and cyano-substituents and is preferably chlorothalonil. The sulfamide fungicides of the present disclosure are preferably selected from dichlofluanid and tolylfluanid. The guanidine fungicides of the present disclosure are preferably selected from dodine, guazantine and iminoctaadine. The triazine fungicide of the present invention is preferably anilazine. The quinone fungicide of the present invention is preferably dithianon.

In an embodiment, the multi-site contact fungicide of the present disclosure is a dithiocarbamate fungicide includes one or more of amobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb and zineb.

An agriculturally acceptable salt of a multi-site contact fungicide may also be used.

It has surprisingly been found that the addition of at least three systemic fungicides to at least one multisite fungicide resulted in surprising and unexpected synergy and other advantages.

In an embodiment, the systemic fungicide combination is a combination of DMI fungicides, QoI fungicides and SDHI fungicides or a combination of DMI and QoI fungicides or a combination of DMI and SDHI fungicides or a combination of SDHI and QoI fungicides.

In an embodiment, the systemic fungicide combination is a combination of at least 3 QoI fungicides.

In an embodiment, the systemic fungicide combination is a combination of at least 3 DMI fungicides.

In an embodiment, the systemic fungicide combination is a combination of at least 3 SDHI fungicides.

Therefore, in an embodiment, the combination of the present disclosure is at least a four-way combination of multisite and systemic fungicides.

Therefore, in an embodiment, the combination of the present invention disclosure resulted in zero phytotoxicity.

Thus, in an aspect, the present disclosure provides a fungicidal combination comprising:
(a) at least one multisite fungicide; and
(b) at least three systemic fungicides selected from DMI fungicides, QoI fungicides, SDHI fungicides, and a combination thereof.

In another embodiment, the present disclosure provides a fungicidal combination comprising:
(a) at least one multisite fungicide; and
(b) at least three DMI fungicides.

In another embodiment, the present disclosure provides a fungicidal combination comprising:
(a) at least one multisite fungicide; and
(b) at least three QoI fungicides.

In another embodiment, the present disclosure provides a fungicidal combination comprising:
(a) at least one multisite fungicide; and
(b) at least three SDHI fungicides.

In another embodiment, the present disclosure provides a fungicidal combination comprising:
(a) at least one multisite fungicide; and
(b) at least one SDHI fungicides and one QoI fungicide.

In another embodiment, the present disclosure provides a fungicidal combination comprising:
(a) at least one multisite fungicide; and
(b) at least one QoI fungicides and one SDHI fungicide.

In another embodiment, the present disclosure provides a fungicidal combination comprising:
(a) at least one multisite fungicide; and
(b) at least one SDHI fungicides and one DMI fungicide.

In another embodiment, the present disclosure provides a fungicidal combination comprising:
(a) at least one multisite fungicide; and
(b) at least one DMI fungicides and one SDHI fungicide.

In another embodiment, the present disclosure provides a fungicidal combination comprising:
(a) at least one multisite fungicide; and
(b) at least one DMI fungicides and one QoI fungicide.

In another embodiment, the present disclosure provides a fungicidal combination comprising:
(a) at least one multisite fungicide; and
(b) at least one QoI fungicides and one DMI fungicide.

In another embodiment, the present disclosure provides a fungicidal combination comprising:
(a) at least one multisite fungicide; and
(b) at least one DMI fungicide, one QoI fungicide and one SDHI fungicide.

In an embodiment, said SDHI fungicide is selected preferably from Benodanil, Flutolanil, Mepronil, Isofetamid, Fluopyram, Fenfuram, Carboxin, Oxycarboxin, Thifluzamide, Benzovindiflupyr, Bixafen, Fluxapyroxad, Furametpyr, Isopyrazam, Penflufen, Penthiopyrad, Sedaxane, Boscalid, Pydiflumetofen, Fluindapyr, Pyraziflumid, Isoflucypram, Inpyrfluxam, Dipymetitrone, and combinations thereof.

In an embodiment, the SDHI fungicide is selected from Pydiflumetofen, Isoflucypram, Inpyrfluxam, Dipymetitrone, Fluindapyr and combinations thereof. However, it should be understood that the choice of SDHI fungicides is not limited to these fungicides alone.

In an embodiment, said SDHI fungicide is Thifluzamide or Benzovindiflupyr or Bixafen or Fluxapyroxad or Isopyrazam, or Boscalid, or Fluindapyr.

In an embodiment, said DMI fungicide is selected preferably from Azaconazole, Bitertanol, Bromuconazole, Cyproconazole, Difenoconazole, Diniconazole, Epoxiconazole, Etaconazole, Fenbuconazole, Fluquinconazole, Flusilazole, Flutriafol, Hexaconazole, Imibenconazole, Ipconazole, Metconazole, Myclobutanil, Penconazole, Propiconazole, Simeconazole, Tebuconazole, Tetraconazole, Triadimefon, Triadimenol, Triticonazole, Prothioconazole, Imazalil, Oxpoconazole, Pefurazoate, Prochloraz, Triflumizole, Triforine, Pyrifenox, Pyrisoxazole, Fenarimol, Nuarimol, Mefentrifluconazole Ipfentrifluconazole, and combinations thereof.

In an embodiment, the DMI fungicide is selected from Cyproconazole, Epoxiconazole, Hexaconazole, Prothioconazole, Tebuconazole, Difenoconazole, Mefentrifluconazole, Ipfentrifluconazole and combinations thereof. However, it should be understood that the choice of DMI fungicides is not limited to these fungicides alone.

In an embodiment, said QoI fungicide is selected preferably from Azoxystrobin, Coumoxystrobin, Enoxastrobin, Flufenoxystrobin, Picoxystrobin, Pyraoxystrobin, Mandestrobin, Pyraclostrobin, Pyrametostrobin, Triclopyricarb, Kresoxim-Methyl, Dimoxystrobin, Fenaminostrobin, Metominostrobin, Famoxadone, Fluoxastrobin, Fenamidone, Pyribencarb, Metyltetraprole, Trifloxystrobin and combinations thereof.

In an embodiment, the QoI fungicide is selected from Metyltetraprole, Azoxystrobin, Picoxystrobin, Pyraclostrobin, Fluoxastrobin, Trifloxystrobin and combinations thereof. However, it should be understood that the choice of QoI fungicides is not limited to these fungicides alone.

An agriculturally acceptable salt of any of the above systemic fungicides may also be used.

In an embodiment, the combination of the disclosure is free from any other fungicide apart from these fungicides. In this embodiment, the fungicidal combination of the invention is a combination of fungicides consisting of these four fungicides described hereinabove in any of the embodiments.

In an embodiment, the combination of the disclosure is free from any other insecticide or herbicide apart from these fungicides.

In an aspect, the fungicidal combination consists essentially of, or consists of a single (one) multisite fungicide and three systemic fungicides.

In an aspect, the combination comprises, consists essentially of, or consists of mancozeb, picoxystrobin, prothioconazole, and difenoconazole.

In any aspect or embodiment described hereinbelow, the phrase comprising may be replaced by the phrases “consisting of” or “consisting essentially of” or “consisting substantially of”. In these aspects or embodiment, the combination or composition described includes or comprises or consists of or consists essentially of or consists substantially of the specific components recited therein, to the exclusion of other fungicides or insecticide or herbicides or plant growth promoting agents or adjuvants or excipients not specifically recited therein.

Below table 1 provides exemplary combinations according to embodiments of present disclosure.

| Sr. | Multisite | First systemic | Second systemic | Third systemic |
|---|---|---|---|---|
| No. | Fungicide | fungicide | fungicide | fungicide |
| 1. | Chlorothalonil | Prothioconazole | Difenoconazole | Picoxystrobin |
| 2. | Chlorothalonil | Prothioconazole | Difenoconazole | Trifloxystrobin |
| 3. | Chlorothalonil | Prothioconazole | Difenoconazole | Fluindapyr |
| 4. | Chlorothalonil | Prothioconazole | Difenoconazole | Fluxapyroxad |
| 5. | Chlorothalonil | Prothioconazole | Difenoconazole | Bixafen |
| 6. | Chlorothalonil | Prothioconazole | Tebuconazole | Picoxystrobin |
| 7. | Chlorothalonil | Prothioconazole | Tebuconazole | Trifloxystrobin |
| 8. | Chlorothalonil | Prothioconazole | Tebuconazole | Fluindapyr |
| 9. | Chlorothalonil | Prothioconazole | Tebuconazole | Fluxapyroxad |
| 10. | Chlorothalonil | Prothioconazole | Tebuconazole | Bixafen |
| 11. | Chlorothalonil | Difenoconazole | Tebuconazole | Picoxystrobin |
| 12. | Chlorothalonil | Difenoconazole | Tebuconazole | Trifloxystrobin |
| 13. | Chlorothalonil | Difenoconazole | Tebuconazole | Fluindapyr |
| 14. | Chlorothalonil | Difenoconazole | Tebuconazole | Fluxapyroxad |
| 15. | Chlorothalonil | Difenoconazole | Tebuconazole | Bixafen |
| 16. | Chlorothalonil | Prothioconazole | Difenoconazole | Azoxystrobin |
| 17. | Chlorothalonil | Difenoconazole | Tebuconazole | Azoxystrobin |
| 18. | Chlorothalonil | Prothioconazole | Tebuconazole | Azoxystrobin |
| 19. | Copper | Prothioconazole | Difenoconazole | Picoxystrobin |
| | Oxychloride | | | |
| 20. | Copper | Prothioconazole | Difenoconazole | Trifloxystrobin |
| | Oxychloride | | | |
| 21. | Copper | Prothioconazole | Difenoconazole | Fluindapyr |
| | Oxychloride | | | |
| 22. | Copper | Prothioconazole | Difenoconazole | Fluxapyroxad |
| | Oxychloride | | | |
| 23. | Copper | Prothioconazole | Difenoconazole | Bixafen |
| | Oxychloride | | | |
| 24. | Copper | Prothioconazole | Tebuconazole | Picoxystrobin |
| | Oxychloride | | | |
| 25. | Copper | Prothioconazole | Tebuconazole | Trifloxystrobin |
| | Oxychloride | | | |
| 26. | Copper | Prothioconazole | Tebuconazole | Fluindapyr |
| | Oxychloride | | | |
| 27. | Copper | Prothioconazole | Tebuconazole | Fluxapyroxad |
| | Oxychloride | | | |
| 28. | Copper | Prothioconazole | Tebuconazole | Bixafen |
| | Oxychloride | | | |
| 29. | Copper | Difenoconazole | Tebuconazole | Picoxystrobin |
| | Oxychloride | | | |
| 30. | Copper | Difenoconazole | Tebuconazole | Trifloxystrobin |
| | Oxychloride | | | |
| 31. | Copper | Difenoconazole | Tebuconazole | Fluindapyr |
| | Oxychloride | | | |
| 32. | Copper | Difenoconazole | Tebuconazole | Fluxapyroxad |
| | Oxychloride | | | |
| 33. | Copper | Difenoconazole | Tebuconazole | Bixafen |
| | Oxychloride | | | |
| 34. | Copper | Difenoconazole | Prothioconazole | Azoxystrobin |
| | Oxychloride | | | |
| 35. | Copper | Difenoconazole | Tebuconazole | Azoxystrobin |
| | Oxychloride | | | |
| 36. | Copper | Prothioconazole | Tebuconazole | Azoxystrobin |
| | Oxychloride | | | |
| 37. | Mancozeb | Prothioconazole | Difenoconazole | Picoxystrobin |
| 38. | Mancozeb | Prothioconazole | Difenoconazole | Trifloxystrobin |
| 39. | Mancozeb | Prothioconazole | Difenoconazole | Fluindapyr |
| 40. | Mancozeb | Prothioconazole | Difenoconazole | Fluxapyroxad |
| 41. | Mancozeb | Prothioconazole | Difenoconazole | Bixafen |
| 42. | Mancozeb | Prothioconazole | Tebuconazole | Picoxystrobin |
| 43. | Mancozeb | Prothioconazole | Tebuconazole | Trifloxystrobin |
| 44. | Mancozeb | Prothioconazole | Tebuconazole | Fluindapyr |
| 45. | Mancozeb | Prothioconazole | Tebuconazole | Fluxapyroxad |
| 46. | Mancozeb | Prothioconazole | Tebuconazole | Bixafen |
| 47. | Mancozeb | Difenoconazole | Tebuconazole | Picoxystrobin |
| 48. | Mancozeb | Difenoconazole | Tebuconazole | Trifloxystrobin |
| 49. | Mancozeb | Difenoconazole | Tebuconazole | Fluindapyr |
| 50. | Mancozeb | Difenoconazole | Tebuconazole | Fluxapyroxad |
| 51. | Mancozeb | Difenoconazole | Tebuconazole | Bixafen |
| 52. | Mancozeb | Fluxapyroxad | Prothioconazole | Picoxystrobin |
| 53. | Mancozeb | Fluxapyroxad | Prothioconazole | Trifloxystrobin |
| 54. | Mancozeb | Prothioconazole | Tebuconazole | Azoxystrobin |
| 55. | Mancozeb | Prothioconazole | Difenoconazole | Azoxystrobin |
| 56. | Mancozeb | Tebuconazole | Difenoconazole | Azoxystrobin |

Below table 2 provides combinations according to embodiments of present disclosure with exemplary dosage in grams active ingredient per hectare (g ai/ha).

In Table 2, unless otherwise indicated, the values indicated in the bracket refer to the dosage in grams active ingredient per hectare (g ai/ha). However, it should be understood that the dose of these fungicides is not limited to these values.

TABLE 2

| Sr. | Multisite | First systemic | Second systemic | Third systemic |
|---|---|---|---|---|
| No. | Fungicide | fungicide | fungicide | fungicide |
| 1. | Mancozeb | Picoxystrobin | Tebuconazole | Prothioconazole |
| | (1050) | (47) | (66) | (47) |
| 2. | Mancozeb | Picoxystrobin | Difenoconazole | Prothioconazole |
| | (1050) | (45) | (56) | (64) |
| 3. | Mancozeb | Picoxystrobin | Difenoconazole | Tebuconazole |
| | (1050) | (45) | (56) | (66) |
| 4. | Mancozeb | Trifloxystrobin | Tebuconazole | Prothioconazole |
| | (1050) | (47) | (66) | (47) |
| 5. | Mancozeb | Trifloxystrobin | Difenoconazole | Prothioconazole |
| | (1050) | (45) | (56) | (64) |
| 6. | Mancozeb | Trifloxystrobin | Difenoconazole | Tebuconazole |
| | (1050) | (45) | (56) | (66) |
| 7. | Mancozeb | Azoxystrobin | Tebuconazole | Prothioconazole |
| | (1050) | (47) | (66) | (47) |
| 8. | Mancozeb | Azoxystrobin | Difenoconazole | Prothioconazole |
| | (1050) | (45) | (56) | (64) |
| 9. | Mancozeb | Azoxystrobin | Difenoconazole | Tebuconazole |
| | (1050) | (45) | (56) | (66) |
| 10. | Chlorothalonil | Picoxystrobin | Tebuconazole | Prothioconazole |
| | (1050) | (47) | (66) | (47) |
| 11. | Chlorothalonil | Picoxystrobin | Difenoconazole | Prothioconazole |
| | (1050) | (45) | (56) | (64) |
| 12. | Chlorothalonil | Picoxystrobin | Difenoconazole | Tebuconazole |
| | (1050) | (45) | (56) | (66) |
| 13. | Chlorothalonil | Trifloxystrobin | Tebuconazole | Prothioconazole |
| | (1050) | (47) | (66) | (47) |
| 14. | Chlorothalonil | Trifloxystrobin | Difenoconazole | Prothioconazole |
| | (1050) | (45) | (56) | (64) |
| 15. | Chlorothalonil | Trifloxystrobin | Difenoconazole | Tebuconazole |
| | (1050) | (45) | (56) | (66) |
| 16. | Chlorothalonil | Azoxystrobin | Tebuconazole | Prothioconazole |
| | (1050) | (47) | (66) | (47) |
| 17. | Chlorothalonil | Azoxystrobin | Difenoconazole | Prothioconazole |
| | (1050) | (45) | (56) | (64) |
| 18. | Chlorothalonil | Azoxystrobin | Difenoconazole | Tebuconazole |
| | (1050) | (45) | (56) | (66) |
| 19. | Copper | Picoxystrobin | Tebuconazole | Prothioconazole |
| | oxychloride | (47) | (66) | (47) |
| | (180 g of | | | |
| | metallic | | | |
| | copper/ha) | | | |
| 20. | Copper | Picoxystrobin | Difenoconazole | Prothioconazole |
| | oxychloride | (45) | (56) | (64) |
| | (180 g of | | | |
| | metallic | | | |
| | copper/ha) | | | |
| 21. | Copper | Picoxystrobin | Difenoconazole | Tebuconazole |
| | oxychloride | (45) | (56) | (66) |
| | (180 g of | | | |
| | metallic | | | |
| | copper/ha) | | | |
| 22. | Copper | Trifloxystrobin | Tebuconazole | Prothioconazole |
| | oxychloride | (47) | (66) | (47) |
| | (180 g of | | | |
| | metallic | | | |
| | copper/ha) | | | |
| 23. | Copper | Trifloxystrobin | Difenoconazole | Prothioconazole |
| | oxychloride | (45) | (56) | (64) |
| | (180 g of | | | |
| | metallic | | | |
| | copper/ha) | | | |
| 24. | Copper | Trifloxystrobin | Difenoconazole | Tebuconazole |
| | oxychloride | (45) | (56) | (66) |
| | (180 g of | | | |
| | metallic | | | |
| | copper/ha) | | | |
| 25. | Copper | Azoxystrobin | Tebuconazole | Prothioconazole |
| | oxychloride | (47) | (66) | (47) |
| | (180 g of | | | |
| | metallic | | | |
| | copper/ha) | | | |
| 26. | Copper | Azoxystrobin | Difenoconazole | Prothioconazole |
| | oxychloride | (45) | (56) | (64) |
| | (180 g of | | | |
| | metallic | | | |
| | copper/ha) | | | |
| 27. | Copper | Azoxystrobin | Difenoconazole | Tebuconazole |
| | oxychloride | (45) | (56) | (66) |
| | (180 g of | | | |
| | metallic | | | |
| | copper/ha) | | | |
| 28. | Mancozeb | Prothioconazole | Tebuconazol | Fluindapyr |
| | (1050) | (47) | (66) | (47) |
| 29. | Mancozeb | Prothioconazole | Difenoconazole | Fluindapyr |
| | (1050) | (47) | (56) | (47) |
| 30. | Mancozeb | Tebuconazol | Difenoconazole | Fluindapyr |
| | (1050) | (66) | (56) | (47) |
| 31. | Mancozeb | Tebuconazol | Difenoconazole | Fluindapyr |
| | (1050) | (66) | (56) | (47) |
| 32. | Chlorothalonil | Prothioconazole | Tebuconazol | Fluindapyr |
| | (1050) | (47) | (66) | (47) |
| 33. | Chlorothalonil | Prothioconazole | Difenoconazole | Fluindapyr |
| | (1050) | (47) | (56) | (47) |
| 34. | Chlorothalonil | Tebuconazol | Difenoconazole | Fluindapyr |
| | (1050) | (66) | (56) | (47) |
| 35. | Chlorothalonil | Tebuconazol | Difenoconazole | Fluindapyr |
| | (1050) | (66) | (56) | (47) |
| 36. | Copper | Prothioconazole | Tebuconazol | Fluindapyr |
| | oxychloride | (47) | (66) | (47) |
| | (180 g of | | | |
| | metallic | | | |
| | copper/ha) | | | |
| 37. | Copper | Prothioconazole | Difenoconazole | Fluindapyr |
| | oxychloride | (47) | (56) | (47) |
| | (180 g of | | | |
| | metallic | | | |
| | copper/ha) | | | |
| 38. | Copper | Tebuconazol | Difenoconazole | Fluindapyr |
| | oxychloride | (66) | (56) | (47) |
| | (180 g of | | | |
| | metallic | | | |
| | copper/ha) | | | |
| 39. | Copper | Tebuconazol | Difenoconazole | Fluindapyr |
| | oxychloride | (66) | (56) | (47) |
| | (180 g of | | | |
| | metallic | | | |
| | copper/ha) | | | |

The combinations of the present disclosure may be formulated in the form of a composition.

In an embodiment, the present disclosure provides a composition comprising a combination as described hereinabove in any one of the aspects or embodiments, and at least one agrochemically acceptable excipient.

In an embodiment, the present disclosure provides a composition consisting of a combination as described hereinabove in any one of the aspects or embodiments, and at least one agrochemically acceptable excipient.

In an embodiment, the present disclosure may provide a composition comprising:
a) at least one multisite fungicide;
b) at least three systemic fungicides selected from DMI fungicides, QoI fungicides, SDHI fungicides, and a combination thereof; and
c) at least one agrochemically acceptable excipient.

In an embodiment, the present disclosure may provide a composition comprising:
a) at least one multisite fungicide;
b) at least three systemic fungicides selected from DMI fungicides, QoI fungicides, SDHI fungicides, and a combination thereof;
c) at least one agrochemically acceptable excipient; and
d) at least one other agrochemical active.

The agrochemical active may include herbicides, insecticides, miticides, acaricide, fertilizers, plant growth regulators, and biocides.

The amount of a composition according to the disclosure to be applied, will depend on various factors, such as the subject of the treatment, for example plants, soil or seeds; the application of treatment, for example spraying, dusting or seed dressing; the purpose of the treatment, for example prophylactic or therapeutic disease control; in case of disease control the type of fungi to be controlled or the application time. This amount of the combinations of the present invention to be applied can be readily deduced by a skilled agronomist.

Thus in an embodiment, the present disclosure may provide combinations comprising:
(a) at least one multisite fungicides selected from Mancozeb, Chlorothalonil, Bag8 and Copper oxychloride;
(b) at least three systemic fungicides selected from DMI fungicides or QoI fungicides or SDHI fungicides, a combination of DMI fungicides, QoI fungicides and SDHI fungicides or a combination of DMI and QoI fungicides or a combination of DMI and SDHI fungicides or a combination of SDHI+QoI fungicides.

Thus in an embodiment, the present disclosure provides combinations comprising:
(a) multisite fungicide chlorothalonil;
(b) at least three systemic fungicides comprising prothioconazole, tebuconazole and one or more selected from picoxystrobin or trifloxystrobin or fluindapyr or fluxapyroxad or bixafen.

Thus in an embodiment, the present disclosure provides combinations comprising:
(a) multisite fungicide chlorothalonil;
(b) at least three systemic fungicides comprising prothioconazole, difenoconazole and one or more selected from picoxystrobin or trifloxystrobin or fluindapyr or fluxapyroxad or bixafen.

Thus in an embodiment, the present disclosure provides combinations comprising:
(a) multisite fungicide chlorothalonil;
(b) at least three systemic fungicides comprising difenoconazole, tebuconazole and one or more selected from picoxystrobin or trifloxystrobin or fluindapyr or fluxapyroxad or bixafen.

Thus in an embodiment, the present disclosure provides combinations comprising:
(a) multi site fungicide copper oxychloride;
(b) at least three systemic fungicides comprising prothioconazole, difenoconazole and one or more selected from picoxystrobin or trifloxystrobin or fluindapyr or fluxapyroxad or bixafen.

Thus in an embodiment, the present disclosure provides combinations comprising:
(a) multisite fungicide copper oxychloride;
(b) at least three systemic fungicides comprising prothioconazole, tebuconazole and one or more selected from picoxystrobin or trifloxystrobin or fluindapyr or fluxapyroxad or bixafen.

Thus in an embodiment, the present disclosure provides combinations comprising:
(a) multisite fungicide copper oxychloride;
(b) at least three systemic fungicides comprising difenoconazole, tebuconazole and one or more selected from picoxystrobin or trifloxystrobin or fluindapyr or fluxapyroxad or bixafen.

Thus in an embodiment, the present disclosure provides combinations comprising:
(a) multisite fungicide mancozeb;
(b) at least three systemic fungicides comprising prothioconazole, difenoconazole and one or more selected from picoxystrobin or trifloxystrobin or fluindapyr or fluxapyroxad or bixafen.

Thus in an embodiment, the present disclosure provides combinations comprising:
(a) multisite fungicide mancozeb;
(b) at least three systemic fungicides comprising prothioconazole, tebuconazole and one or more selected from picoxystrobin or trifloxystrobin or fluindapyr or fluxapyroxad or bixafen.

Thus in an embodiment, the present disclosure provides combinations comprising:
(a) multisite fungicide mancozeb;
(b) at least three systemic fungicides comprising difenoconazole, tebuconazole and one or more selected from picoxystrobin or trifloxystrobin or fluindapyr or fluxapyroxad or bixafen.

Thus in an embodiment, the present disclosure provides combinations comprising:
(a) multisite fungicide mancozeb;
(b) at least three systemic fungicides comprising fluxapyroxad, prothioconazole and one or more selected from picoxystrobin or trifloxystrobin or fluindapyr or fluxapyroxad or bixafen.

In an embodiment, the total amount of multisite fungicides in the composition may typically be in the range of 0.1 to 99% by weight, preferably 0.2 to 90% by weight. The total amount of at least three systemic fungicides in the composition may be in the range of 0.1 to 99% by weight.

In an aspect, the amount of multisite fungicide in the combination is about 100 g ai/ha to about 5000 g ai/ha, or about 120 g ai/ha to about 3000 g ai/ha, or about 150 g ai/ha to about 2500 g ai/ha, or about 180 g ai/ha to about 2000 g ai/ha.

In an aspect, the total amount of systemic fungicide in the combination is about 80 ai/ha to about 1000 ai/ha, or about 90 ai/ha to about 750 ai/ha, or about 100 ai/ha to about 500 ai/ha.

In an embodiment, the constituent fungicides of the combination of the present disclosure may be admixed in ratio of (1-80):(1-80):(1-80):(1-80) of the multisite fungicides and at least three systemic fungicides respectively.

In an embodiment, the weight ratio of multisite fungicides to QoI fungicide is about 2:1 to about 80:1, or about 5:1 to about 50:1, or about 10:1 to about 35:1. In an aspect, the weight ratio of multi site fungicides to DMI fungicide is about 2:1 to about 80:1, or about 5:1 to about 50:1, or about 10:1 to about 35:1. In an aspect, the weight ratio of multisite fungicides to SDHI fungicide is about 2:1 to about 80:1, or about 5:1 to about 50:1, or about 10:1 to about 35:1.

In an embodiment, the weight ratio of multisite fungicide to total amount of systemic fungicide is about 2:1 to about 10:1, or about 3:1 to about 10:1, or about 3.5:1 to about 9.5:1.

In an embodiment, the constituents of the composition of the present disclosure are tank mixed and sprayed at the locus of the infection or are alternatively be mixed with surfactants and then sprayed.

In an embodiment, the constituents of the composition of the present disclosure may be used for foliar application, ground or applications to plant propagation materials.

In an embodiment, the compositions of the present disclosure are produced by mixing the actives in the composition with an inert carrier, and adding surfactants and other adjuvants and carriers as needed and formulated into solid, or liquid formulations, including but not limited to wettable powders, granules, dusts, soluble (liquid) concentrates, suspension concentrates (SCs), oil in water emulsion, water in oil emulsion, emulsifiable concentrates (ECs), capsule suspensions, ZC formulations, oil dispersions or other known formulation types. The composition may also be used for treatment of a plant propagation material.

Examples of the solid carrier used in the formulation include fine powders or granules such as minerals such as kaolin clay, attapulgite clay, bentonite, montmorillonite, acid white clay, pyrophyllite, talc, diatomaceous earth and calcite; natural organic materials such as corn rachis powder and walnut husk powder; synthetic organic materials such as urea; salts such as calcium carbonate and ammonium sulfate; synthetic inorganic materials such as synthetic hydrated silicon oxide.

Examples of the liquid carrier include aromatic hydrocarbons such as xylene, alkylbenzene and methylnaphthalene; alcohols such as 2-propanol, ethyleneglycol, propylene glycol, and ethylene glycol monoethyl ether; ketones such as acetone, cyclohexanone and isophorone; vegetable oil such as soybean oil and cotton seed oil; petroleum aliphatic hydrocarbons, esters, dimethylsulfoxide, acetonitrile and water.

Examples of the surfactant include anionic surfactants such as alkyl sulfate ester salts, alkylaryl sulfonate salts, dialkyl sulfosuccinate salts, polyoxyethylene alkylaryl ether phosphate ester salts, lignosulfonate salts and naphthalene sulfonate formaldehyde polycondensates; and nonionic surfactants such as polyoxyethylene alkyl aryl ethers, polyoxyethylene alkylpolyoxypropylene block copolymers and sorbitan fatty acid esters and cationic surfactants such as alkyltrimethylammonium salts.

Examples of the other auxiliary agents that can be included in the composition include water-soluble polymers such as polyvinyl alcohol and polyvinylpyrrolidone, polysaccharides such as guma Arabic gum, alginic acid and the salt thereof, CMC (carboxymethyl-cellulose), Xanthan gum, inorganic materials such as aluminum magnesium silicate and alumina sol, preservatives, coloring agents and stabilization agents such as PAP (acid phosphate isopropyl) and BHT.

The compositions according to the present disclosure are effective for the treating and preventing the plant diseases described below:

Diseases in rice include Blast (Magnaporthe grisea), Helminthosporium leaf spot (Cochliobolus miyabeanus), sheath blight (Rhizoctonia solani), and bakanae disease (Gibberella fujikuroi).

Diseases in wheat include powdery mildew (Erysiphe graminis), Fusarium head blight (Fusarium graminearum, F. avenacerum, F. culmorum, Microdochium nivale), rust (Puccinia striiformis, P. graminis, P. recondita), pink snow mold (Micronectriella nivale), Typhula snow blight (Typhula sp.), loose smut (Ustilago tritici), bunt (Tilletia caries), eyespot (Pseudocercosporella herpotrichoides), leaf blotch (Mycosphaerella graminicola), glume blotch (Stagonospora nodorum), septoria, and yellow spot (Pyrenophora tritici-repentis).

Diseases of barley include powdery mildew (Erysiphe graminis), Fusarium head blight (Fusarium graminearum, F. avenacerum, F. culmorum, Microdochium nivale), rust (Puccinia striiformis, P. graminis, P. hordei), loose smut (Ustilago nuda), scald (Rhynchosporium secalis), net blotch (Pyrenophora teres), spot blotch (Cochliobolus sativus), leaf stripe (Pyrenophora graminea), and Rhizoctonia damping-off (Rhizoctonia solani).

Diseases in corn include smut (Ustilago maydis), brown spot (Cochliobolus heterostrophus), copper spot (Gloeocercospora sorghi), southern rust (Puccinia polysora), gray leaf spot (Cercospora zeae-maydis), white spot (Phaeosphaeria mydis and/or Pantoea ananatis) and Rhizoctonia damping-off (Rhizoctonia solani).

Diseases of citrus include melanose (Diaporthe citri), scab (Elsinoe fawcetti), penicillium rot (Penicillium digitatum, P. italicum), and brown rot (Phytophthora parasitica, Phytophthora citrophthora).

Diseases of apple include blossom blight (Monilinia mali), canker (Valsa ceratosperma), powdery mildew (Podosphaera leucotricha), Alternaria leaf spot (Alternaria alternata apple pathotype), scab (Venturia inaequalis), powdery mildew, bitter rot (Colletotrichum acutatum), crown rot (Phytophtora cactorum), blotch (Diplocarpon mali), and ring rot (Botryosphaeria berengeriana).

Diseases of pear include scab (Venturia nashicola, V. pirina), powdery mildew, black spot (Alternaria alternata Japanese pear pathotype), rust (Gymnosporangium haraeanum), and phytophthora fruit rot (Phytophtora cactorum).

Diseases of peach include brown rot (Monilinia fructicola), powdery mildew, scab (Cladosporium carpophilum), and phomopsis rot (Phomopsis sp.).

Diseases of grape include anthracnose (Elsinoe ampelina), ripe rot (Glomerella cingulata), powdery mildew (Uncinula necator), rust (Phakopsora ampelopsidis), black rot (Guignardia bidwellii), botrytis, and downy mildew (Plasmopara viticola).

Diseases of Japanese persimmon include anthracnose (Gloeosporium kaki), and leaf spot (Cercospora kaki, Mycosphaerella nawae).

Diseases of gourd include anthracnose (Colletotrichum lagenarium), powdery mildew (Sphaerotheca fuliginea), gummy stem blight (Mycosphaerella melonis), Fusarium wilt (Fusarium oxysporum), downy mildew (Pseudoperonospora cubensis), Phytophthora rot (Phytophthora sp.), and damping-off (Pythium sp).

Diseases of tomato include early blight (Alternaria solani), leaf mold (Cladosporium fulvum), and late blight (Phytophthora infestans).

Diseases of eggplant include brown spot (Phomopsis vexans), and powdery mildew (Erysiphe cichoracearum) Diseases of cruciferous vegetables: Alternaria leaf spot (Alternaria japonica), white spot (Cercosporella brassicae), clubroot (Plasmodiophora brassicae), and downy mildew (Peronospora parasitica).

Diseases of onion include rust (Puccinia allii), and downy mildew (Peronospora destructor).

Diseases of soybean include purple seed stain (Cercospora kikuchii), sphaceloma scad (Elsinoe glycines), pod and stem blight (Diaporthe phaseolorum var. sojae), septoria brown spot (Septoria glycines), frogeye leaf spot (Cercospora sojina), rust (Phakopsora pachyrhizi, Phakopsora meibomiae), Yellow rust, brown stem rot (Phytophthora sojae), and Rhizoctonia damping-off (Rhizoctonia solani).

Diseases of kidney bean include anthracnose (Colletotrichum lindemthianum). Diseases of peanut: leaf spot (Cercospora personata), brown leaf spot (Cercospora arachidicola) and southern blight (Sclerotium rolfsii).

Diseases of garden pea include powdery mildew (Erysiphe pisi), and root rot (Fusarium solani f. sp. pisi).

Diseases of potato include early blight (Alternaria solani), late blight (Phytophthora infestans), pink rot (Phytophthora erythroseptica), and powdery scab (Spongospora subterranean f sp. subterranea).

Diseases of strawberry include powdery mildew (Sphaerotheca humuli), and anthracnose (Glomerella cingulata).

Diseases of tea include net blister blight (Exobasidium reticulatum), white scab (Elsinoe leucospila), gray blight (Pestalotiopsis sp.), and anthracnose (Colletotrichum theae-sinensis).

Diseases of tobacco include brown spot (Alternaria longipes), powdery mildew (Erysiphe cichoracearum), anthracnose (Colletotrichum tabacum), downy mildew (Peronospora tabacina), and black shank (Phytophthora nicotianae).

Diseases of rapeseed include sclerotinia rot (Sclerotinia sclerotiorum), and Rhizoctonia damping-off (Rhizoctonia solani). Diseases of cotton: Rhizoctonia damping-off (Rhizoctonia solani).

Diseases of sugar beat include Cercospora leaf spot (Cercospora beticola), leaf blight (Thanatephorus cucumeris), Root rot (Thanatephorus cucumeris), and Aphanomyces root rot (Aphanomyces cochlioides).

Diseases of rose include black spot (Diplocarpon rosae), powdery mildew (Sphaerotheca pannosa), and downy mildew (Peronospora sparsa). Diseases of chrysanthemum and asteraceous plants: downy mildew (Bremia lactucae), leaf blight (Septoria chrysanthemi-indici), and white rust (Puccinia horiana).

Diseases of various groups include diseases caused by Pythium spp. (Pythium aphanidermatum, Pythium debarianum, Pythium graminicola, Pythium irregulare, Pythium ultimum), gray mold. (Botrytis cinerea), and Sclerotinia rot (Sclerotinia sclerotiorum).

Disease of Japanese radish include Alternaria leaf spot (Alternaria brassicicola).

Diseases of turfgrass include dollar spot (Sclerotinia homeocarpa), and brown patch and large patch (Rhizoctonia solani).

Disease of banana include Black sigatoka (Mycosphaerella fijiensis), Yellow sigatoka (Mycosphaerella musicola).

Disease of sunflower include downy mildew (Plasmopara halstedii).

Seed diseases or diseases in the early stages of the growth of various plants caused by Aspergillus spp., Penicillium spp., Fusarium spp., Gibberella spp., Tricoderma spp., Thielaviopsis spp., Rhizopus spp., Mucor spp., Corticium spp., Phoma spp., Rhizoctonia spp. and Diplodia spp.

Viral diseases of various plants mediated by Polymixa spp. or Olpidium spp.

The compositions of the present disclosure can be used in agricultural lands such as fields, paddy fields, lawns and orchards or in non-agricultural lands. The present disclosure may be used to control diseases in agricultural lands for cultivating the plants without any phytotoxicity to the plant.

Examples of the crops on which the present compositions may be used include but are not limited to corn, rice, wheat, barley, rye, oat, sorghum, cotton, soybean, peanut, buckwheat, beet, rapeseed, sunflower, sugar cane, tobacco; vegetables: solanaceous vegetables such as eggplant, tomato, pimento, pepper, potato, cucurbit vegetables such as cucumber, pumpkin, zucchini, water melon, melon, squash, cruciferous vegetables such as radish, white turnip, horseradish, kohlrabi, Chinese cabbage, cabbage, leaf mustard, broccoli, cauliflower, asteraceous vegetables such as burdock, crown daisy, artichoke, lettuce, liliaceous vegetables such as green onion, onion, garlic, and asparagus, ammiaceous vegetables such as carrot, parsley, celery, parsnip, chenopodiaceous vegetables such as spinach, Swiss chard, lamiaceous vegetables such as Perilla frutescens, mint, basil, strawberry, sweet potato, Dioscorea japonica, Colocasia, flowers, foliage plants, turf grasses, fruits: pome fruits such apple, pear, quince, etc, stone fleshy fruits such as peach, plum, nectarine, Prunus mume, cherry fruit, apricot, prune, citrus fruits such as orange, lemon, rime, grapefruit, nuts such as chestnuts, walnuts, hazelnuts, almond, pistachio, cashew nuts, macadamia nuts, berries such as blueberry, cranberry, blackberry, raspberry, grape, kaki fruit, olive, plum, banana, coffee, date palm, coconuts, trees other than fruit trees; tea, mulberry, flowering plant, trees such as ash, birch, dogwood, Eucalyptus, Ginkgo biloba, lilac, maple, Quercus, poplar, Judas tree, Liquidambar formosana, plane tree, Zelkova, Japanese arborvitae, fir wood, hemlock, juniper, Pinus, Picea, and Taxus cuspidate.

In an aspect, the present disclosure may provide methods of controlling fungal diseases comprising applying a combination comprising:
a) at least one multi site fungicide; and
b) at least three systemic fungicides selected from DMI fungicides, QoI fungicides, SDHI fungicides and a combination thereof.

In an embodiment, the multisite fungicide and the at least three systemic fungicides may be selected according to any of the preferred embodiments of the combinations described hereinabove.

The combinations of the present disclosure may be sold as a pre-mixed composition. Alternatively, the multisite fungicide and at least three systemic fungicides may be provided individually as separate parts of a kit and may be mixed together before spraying. At least one adjuvant may also be included with the kit and mixed together with the multisite fungicide and at least three systemic fungicides. Alternatively, the kit may contain a mixture of the multisite fungicide and at least three systemic fungicides and at least one separate adjuvant such that the mixture and the at least one adjuvant are tank mixed before spraying.

The composition of the present disclosure maybe applied simultaneously as a tank mix or formulation or the multisite fungicide and at least three systemic fungicides may be applied sequentially. Alternatively, the application may be a post-emergent application. The application may be made to the soil before emergence of the plants, either pre-planting or post-planting. The application may be made as a foliar spray at different timings during crop development, with either one or two applications early or late post-emergence.

The compositions according to this disclosure can be applied before or after infection of the plants or the propagation material thereof by the fungi.

### One or More Advantages of the Present Disclosure

In an embodiment, the present disclosure provides a combination of multisite fungicide and least three systemic fungicides selected from DMI fungicides, QoI fungicides, SDHI fungicides or a combination thereof.

Multiple treatments with different combinations were tested for their effectiveness for the control of Microsphaera diffusa and Phakopsora pachyrhizi that respectively cause Powdery Mildew and Asian Soybean Rust. The combinations were also tested against Corynespora cassiicola and Septoria glycines. Combinations of multisite fungicide with at least three systemic fungicides were found to be significantly more effective in controlling the diseases than combinations of multisite fungicide with two systemic fungicides or a combination of two multisite fungicides with one systemic fungicide.

The instant application, for the first time, describes a fungicidal combination comprising a multisite fungicide and at least three systemic fungicides selected from DMI fungicides, QoI fungicides, SDHI fungicides, and a combination thereof to provide a long-awaited solution to the problem of maintaining efficacy of the combinations in controlling fungi and their associated diseases.

In addition to addressing the long-standing need in the industry, the synergistic complementation between the multisite fungicide and the combination of three other systemic fungicides was found to be both unexpected and surprising.

It has further been found that application of these combinations resulted in zero phytotoxicity.

These surprising advantages of the combinations of the disclosure were not observed when multisite fungicides were combined with two systemic fungicides or two multisite fungicides were combined with one systemic fungicide.

The research conducted by the inventors, and the subject matter disclosed and claimed, in the instant application, found that the addition of a multisite fungicide to a combination of three systemic fungicides reverses the decay of efficacy of the known combination and reverts it to the original known efficacy or even better efficacy.

While the foregoing written description of the disclosure enables one of ordinary skill to make and use what is considered presently to be the best mode thereof, those of ordinary skill will understand and appreciate the existence of variations, combinations, and equivalents of the specific embodiment, method, and examples herein. The disclosure should therefore not be limited by the above described embodiment, method, and examples, but by all embodiments and methods within the scope and spirit of the invention.

### EXAMPLES

Following treatments were checked on Soybean crop for effectiveness against Powdery Mildew caused by Microsphaera diffusa. Spray volume was 150 L/ha. All of the treatments showed zero phytotoxicity.

TABLE 3

| Treatment. | Active | | | % control of |
|---|---|---|---|---|
| No. | Ingredient | Dose | | Microsphaera diffusa |
| 1. | Check | — | | 0 |
| 2. | Prothioconazole | 42.7 | g ai/ha | 91.7 |
| | Picoxystrobin | 30 | g ai/ha | |
| | Difenoconazole | 37.5 | g ai/ha | |
| | Mancozeb | 1050 | g ai/ha | |
| | Methyl ester of | 270 | g ai/ha | |
| | Soybean oil | | | |
| 3. | Prothioconazole | 64 | g ai/ha | 95.8 |
| | Picoxystrobin | 45 | g ai/ha | |
| | Difenoconazole | 56.25 | g ai/ha | |
| | Mancozeb | 1050 | g ai/ha | |
| | Methyl ester of | 270 | g ai/ha | |
| | Soybean oil | | | |
| 4. | Picoxystrobin | 125 | g ai/ha | 66.7 |
| | Fluazinam | 250 | g ai/ha | |
| | Mancozeb | 1050 | g ai/ha | |
| | Methyl ester of | 270 | g ai/ha | |
| | Soybean oil | | | |
| 5. | Picoxystrobin | 75 | g ai/ha | 70.0 |
| | Difenoconazole | 75 | g ai/ha | |
| | Mancozeb | 1050 | g ai/ha | |
| | Methyl ester of | 270 | g ai/ha | |
| | Soybean oil | | | |
| 6. | Picoxystrobin | 75 | g ai/ha | 75 |
| | Difenoconazole | 75 | g ai/ha | |
| | Chlorothalonil | 1050 | g ai/ha | |
| | Methyl ester of | 270 | g ai/ha | |
| | Soybean oil | | | |

It is very apparent from the above table that treatment number 2 and 3 that had combination of multisite fungicides with three systemic fungicides resulted in better pest control as compared to treatments 4, 5 and 6 that had combination of one multisite fungicide with two systemic fungicides or two multisite fungicides with one systemic fungicide.

Following treatments were checked on Soybean crop for effectiveness against Asian Soybean Rust caused by Phakopsora pachyrhizi. Spray volume was 150 L/ha. All of the treatments showed zero phytotoxicity.

TABLE 4

| Treatment. | Active | | | % control of |
|---|---|---|---|---|
| No. | Ingredient | Dose | | Phakopsora pachyrhizi |
| 1. | Check | — | | 0 |
| 2. | Prothioconazole | 42.7 | g ai/ha | 81.1 |
| | Picoxystrobin | 30 | g ai/ha | |
| | Difenoconazole | 37.5 | g ai/ha | |
| | Mancozeb | 1050 | g ai/ha | |
| | Methyl ester of | 270 | g ai/ha | |
| | Soybean oil | | | |
| 3. | Prothioconazole | 64 | g ai/ha | 86.8 |
| | Picoxystrobin | 45 | g ai/ha | |
| | Difenoconazole | 56.25 | g ai/ha | |
| | Mancozeb | 1050 | g ai/ha | |
| | Methyl ester of | 270 | g ai/ha | |
| | Soybean oil | | | |
| 4. | Picoxystrobin | 125 | g ai/ha | 78.0 |
| | Fluazinam | 250 | g ai/ha | |
| | Mancozeb | 1050 | g ai/ha | |
| | Methyl ester of | 270 | g ai/ha | |
| | Soybean oil | | | |
| 5. | Picoxystrobin | 75 | g ai/ha | 79.9 |
| | Difenoconazole | 75 | g ai/ha | |
| | Mancozeb | 1050 | g ai/ha | |
| | Methyl ester of | 270 | g ai/ha | |
| | Soybean oil | | | |
| 6. | Fluazinam | 500 | g ai/ha | 47.3 |
| | Difenoconazole | 75 | g ai/ha | |
| | Mancozeb | 1050 | g ai/ha | |
| | Methyl ester of | 270 | g ai/ha | |
| | Soybean oil | | | |

It is very apparent from the above table that treatment number 2 and 3 that had combination of multisite fungicides with three systemic fungicides resulted in better pest control as compared to treatments 4, 5 and 6 that had combination of one multisite fungicide with two systemic fungicides or two multisite fungicides with one systemic fungicide.

Following treatments were checked on Soybean crop for effectiveness against Corynespora cassiicola. Spray volume was 150 L/ha. Crop yield was also recorded.

TABLE 5

| | | | | % control of | |
|---|---|---|---|---|---|
| Treatment. | Active | | | Corynespora | |
| No. | Ingredient | Dose | | cassiicola | % yield |
| 1. | Check | — | | 0 | 62.1 |
| 2. | Prothioconazole | 64 | g ai/ha | 79.1 | 67.2 |
| | Picoxystrobin | 45 | g ai/ha | | |
| | Difenoconazole | 56 | g ai/ha | | |
| | Mancozeb | 1050 | g ai/ha | | |
| 3. | Picoxystrobin | 70 | g ai/ha | 52.0 | 72.5 |
| | Difenoconazole | 75 | g ai/ha | | |
| | Chlorotalonil | 1050 | g ai/ha | | |

It is very apparent from the above table that treatment number 2 that had combination of multisite fungicides with three systemic fungicides resulted in better pest control as compared to treatment 3 that had combination of one multisite fungicide with two systemic fungicides.

Following treatments were checked on Soybean crop for effectiveness against Septoria glycines. Spray volume was 150 L/ha.

TABLE 6

| Treatment. | Active | | | % control of |
|---|---|---|---|---|
| No. | Ingredient | Dose | | Septoria glycines |
| 1. | Check | — | | 0 |
| 2. | Prothioconazole | 64 | g ai/ha | 76.8 |
| | Picoxystrobin | 45 | g ai/ha | |
| | Difenoconazole | 56 | g ai/ha | |
| | Mancozeb | 1050 | g ai/ha | |
| 3. | Picoxystrobin | 70 | g ai/ha | 61.9 |
| | Difenoconazole | 75 | g ai/ha | |
| | Chlorotalonil | 1050 | g ai/ha | |

It is very apparent from the above table that treatment number 2 that had combination of multisite fungicides with three systemic fungicides resulted in better pest control as compared to treatment 3 that had combination of one multisite fungicide with two systemic fungicides.

1. A fungicidal combination comprising:
(a) at least one multisite fungicide; and
(b) at least three systemic fungicides.

2. The fungicidal combination as claimed in claim 1, wherein the at least three systemic fungicides comprise at least three DMI fungicide, at least three Qol fungicides, or at least three SDHI fungicides.

3. The fungicidal combination as claimed in claim 1, wherein the at least three systemic fungicides comprises an SDHI fungicides and a DMI fungicide.

4. The fungicidal combination as claimed in claim 1, wherein the at least three systemic fungicides comprises an SDHI fungicides and a Qol fungicide.

5. The fungicidal combination as claimed in claim 1, wherein the at least three systemic fungicides comprises a DMI fungicides and Qol fungicide.

6. The fungicidal combination as claimed in claim 1, wherein the at least three systemic fungicides comprises a DMI fungicide, a Qol fungicide, and an SDHI fungicide

7. The fungicidal combination as claimed in claim 1, wherein the at least one multisite fungicide is selected from copper fungicides, sulfur fungicides, dithiocarbamate fungicides, phthalimide fungicides, chloronitrile fungicides, sulfamide fungicides, guanidine fungicides, triazines fungicides, quinone fungicides, and combinations thereof.

8. The fungicidal combination as claimed in claim 1, wherein the at least three systemic fungicides comprises an SDHI fungicide selected from benodanil, flutolanil, mepronil, isofetamid, fluopyram, fenfuram, carboxin, oxycarboxin, thifluzamide, benzovindiflupyr, bixafen, fluxapyroxad, furametpyr, isopyrazam, penflufen, penthiopyrad, sedaxane, boscalid, pydiflumetofen, fluindapyr, pyraziflumid, isoflucypram, inpyrfluxam, dipymetitrone, and combinations thereof.

9. The fungicidal combination as claimed in claim 1, wherein the at least three systemic fungicides comprises a DMI fungicide selected from azaconazole, bitertanol, bromuconazole, cyproconazole, difenoconazole, diniconazole, epoxiconazole, etaconazole, fenbuconazole, fluquinconazole, flusilazole, flutriafol, epoxiconazole, imibenconazole, ipconazole, metconazole, myclobutanil, penconazole, propiconazole, simeconazole, tebuconazole, tetraconazole, triadimefon, triadimenol, tri-ti-conazole, prothioconazole, imazalil, oxpoconazole, pefurazoate, prochloraz, triflumizole, triforine, pyrifenox, pyrisoxazole, fenarimol, nuarimol, mefentrifluconazole, ipfentrifluconazole, and combinations thereof.

10. The fungicidal combination as claimed in claim 1, wherein the at least three systemic fungicides comprises a Qol fungicide selected from azoxystrobin, coumoxystrobin, enoxastrobin, flufenoxystrobin, picoxystrobin, pyraoxystrobin, mandestrobin, pyraclostrobin, pyrametostrobin, triclopyricarb, kresoxim-methyl, dimoxystrobin, fenaminostrobin, metominostrobin, famoxadone, fluoxastrobin, fenamidone, pyribencarb, metyltetraprole, trifloxystrobin, ands combinations thereof.

11. A fungicidal composition comprising the combination of claim 1 and an agronomically acceptable excipient

12. The fungicidal composition as claimed in claim 11,
wherein the at least three systemic fungicides are selected from DMI fungicides, Qol fungicides, SDHI fungicides, and combinations thereof.

13. A method of controlling fungal diseases at a locus comprising applying the combination of claim 1 to the locus.

14. The method of controlling fungal diseases as claimed in claim 13,
wherein the at least three systemic fungicides are selected from DMI fungicides, Qol fungicides, SDHI fungicides, and combinations thereof.
